(19) United States
(12) Patent Application Publication
(10) Pub. No.: US 2020/0364668 A1
(43) Pub. Date: Nov. 19, 2020

(54) Online Platform for Media Content Organization and Film Direction

(71) Applicant: Furkan Altunkaynak, Santa Barbara, CA (US)

(72) Inventor: Furkan Altunkaynak, Santa Barbara, CA (US)

(21) Appl. No.: 16/415,834

(22) Filed: May 17, 2019

(51) Int. Cl. G06Q 10/10; G06F 3/0481; G06F 3/0484

(52) U.S. Cl. CPC G06Q 10/101; G06F 2203/04806; G06F 3/04847; G06F 3/0481

(57) ABSTRACT

A film production organization and planning platform and system is described. The platform acts as an easy-to-use, online and networked replacement for the conventional director's folder used in preproduction and on the set of film productions. From notes relating to the script, to visually scripting out each scene with blocking, lighting, makeup, characters, costumes, and more, the platform is configured to be used by every department of the production in concert. Each department may view each other department's work and contributions, and can provide notes or edits in real-time online from any location.

### FIELD OF THE PRESENT INVENTION

The present invention relates in film organization and creation devices, and more specifically relates to a platform and system for networked planning of all aspects of the organization, production, and direction of a film.

### BACKGROUND OF THE PRESENT INVENTION

Media creation and production is a daunting task, especially when the production medium is film. Each individual scene requires extensive planning. Additionally, often many individual frames of a scene require exhaustive planning for proper execution. So many elements are a factor within each scene. Some of these elements include: props, blocking, timing, music, sound effects, characters, character costume, character makeup/hair, lighting, filming angles, filming locations, scheduled time of filming, and editing. Each one of these elements requires a choice as well as scheduling, much of which can be forgotten or lost when sharing the pertinent information with the appropriate participant (actors, grips, lighting technicians, makeup artists, etc.)

During pre-production, most film crews employ a form of physical folder to maintain schedules and organize ideas as they pertain to the production, which is colloquially referred to as “The Director's Folder” or the “Production Bible” in the film industry. Within the folder, the director of the production generally records notes based on the script. Additionally, there are many sub-folders within the folder, each pertaining to a different department relating to the production, such as the costume department, makeup department, cinematography, editing department, etc.

Previously, the director used to write everything he or she imagined about every single scene in the movie for every department. Then, copies of these sections of the folder go to the department heads of the various departments, where the ideas are developed further, and argued. Then, the folder is sent back to the director. This cycle is repeated multiple times until the production is ready to shoot.

Cinematography departments need to know what kind of costume or props are going to be used in each scene for each film so that the cinematography department can decide what kind of lighting or film stocks are going to be used based on the color or the texture that is placed the front of the camera by the other departments. All the departments need to organize and collaborate together, and ideally should have some easy access to each other's ideas. There also must be an easy means of communication between the departments, while maintaining the capacity to view each other's work without disturbing each other.

Unfortunately, this process is time-consuming, and is a difficult task to master for beginning film makers. If there was a way to expedite and facilitate pre-production, films could be made with more effective collaboration, and films could begin shooting much earlier.

Thus, there is a need for a new pre-production organization system and platform, which can effectively replace the director's folder. Such a system is preferably configured to facilitate pre-production to the extent that even individuals without experience in filmmaking can properly structure a film, and make a movie. With such a system and platform, users are preferably equipped with the tools and organizational structure to be able to bring their ideas to producers, companies, or hire people to write out the production in script form, or to fill in the blanks for them. The platform is preferably designed to be used throughout every stage of the film making process, including during shooting, in preproduction, as well as in post-production.

From a no budget movie to big budget Hollywood movies—such a platform is preferably robust enough to satisfy everybody, including short student movies with no budget, to large multi-million-dollar productions. Big budget films have more than 50 individual departments who need some connection with each other to order to act like an excellent symphony orchestra. In most cases, the crew of these large productions are separated around the world in many different countries to work on one project, like 3D design in Canada, set in Morocco, and producers in America etc.

The platform and system of the present invention is designed to remove the need for countless phone calls and emails during the pre-production process, as the platform provides a superior means of information exchange. Effectively, the system and platform preferably provides one large wall, with an inherent multi-level zooming feature, which enables each department to view the big picture, including everyone else's work and ideas, while organizing and managing their own.

There are presently few solutions on the market to attempt to solve this issue. Tools such as Microsoft™ PowerPoint™ lack the scale required to properly organize such a high number of departments, and their ideas may not be edited in real-time online in all scenarios. Other products such as Prezi™ provides an adequate scaling view, with multi-level zooming similar to the present invention, however it is not configured to handle a high number of slides with various media forms present within each cell. As such, Prezi is slow, and the platform freezes after it is filled with numerous forms of media compiled with its own frame cells. In short, Prezi is not configured to handle the multi-department, global scale of a film production adequately, while providing some users real-time viewing, and those with permission, real-time editing within the platform.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

The present invention is a film development, organization, and synchronization platform and system configured for use by a film crew. As such, the present invention is a platform that provides easy, fast access to each department of a film production to view the work of other departments so that they may perform their job faster. In short, the present invention provides a large, view-scalable wall which contains every element of the production by every department.

The preferred embodiment of the present invention can be seen as a form of ‘cake mold’ for film production, which provides a ready-to-use solution for both the aspiring filmmaker, and the professional director. All an individual needs is to fill-in-the-blanks with his or her ideas relating to the production, and as more people are added to the production (including other departments), more ideas become visible and are clarified within the overall scope of the production, well before the production is shot.

The present invention provides an online platform for the construction and visualization of every component of a film production, including scene layouts, continuity progression, sound integration, characters, character blocking, choreography, lighting, location planning, shooting schedules/calendar, makeup, and other elements common to a conventional modern film.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows a screenshot of the platform of the present invention, showing the overall production picture view, completely zoomed-out.

FIG. 2 shows a screenshot of the platform of the present invention, detailing the emotional timeline progression (emotion lines) of the production within a zoomed-out shot of the overall production view.

FIG. 3 depicts a flow chart detailing the process of use of the present invention.

FIG. 4 depicts a flow chart detailing an example usage scenario of the platform and system of the present invention by creating a new project.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

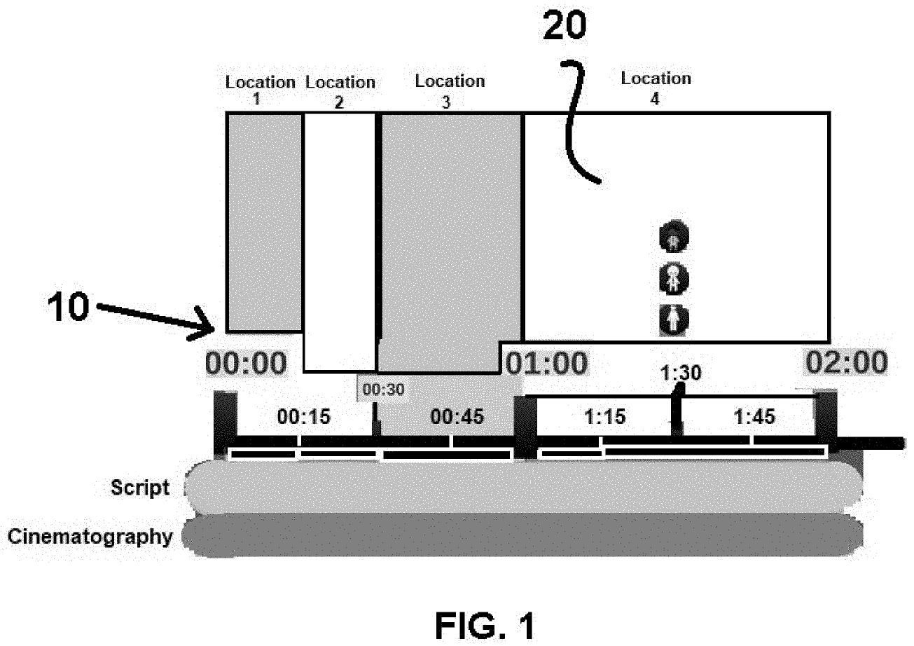

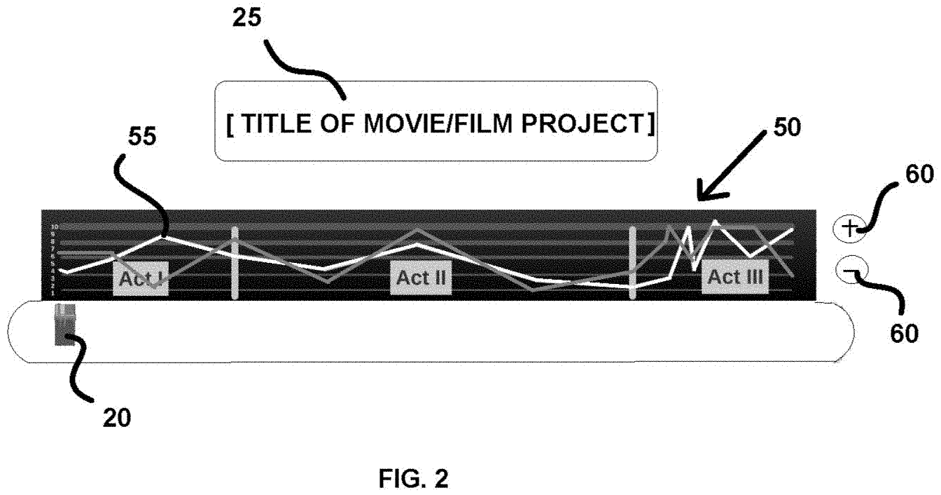

The present invention is an online platform, system, and application configured for use by the film industry to facilitate planning, blocking, organizing, and other production tasks related to the creation of one or more videos, namely films, short films, and television shows. The platform of the present invention is infinitely scalable, and enables multiple users to work simultaneously on a project, with any and all changes made being displayed to all users in real time as they are made. The platform and system of the present invention is preferably accessible from a variety of internet-connected devices, including computers, smartphones, tablet computers, and other similar internet-connected devices equipped with a display screen. From all devices, a stand-alone application may facilitate connection to a secured server computer disposed in communication with the platform of the present invention. Navigation to a specific web address enables manipulation of the platform and system of the present invention from any internet-connected device. The platform and system of the present invention centers around a wall (20) which is a view of the entire project in a scalable format. The wall (20) includes the film title (25), which is preferably depicted at the top of each view as seen in FIG. 1 and FIG. 2.

Planning files created on the platform of the present invention are preferably stored remotely on the secured server computer. Storage for users is available upon creation of a user account. Each user preferably has an independent user account, which is created prior to use of the platform. User account creation generally entails the user selecting a username and password for use on the platform. Users may optionally provide additional content, such as a user profile image, as well as user details. It is envisioned that users are permitted 30 days of free use of the system and platform of the present invention before funds are requested by the system from the user(s).

As shown in FIG. 1, upon launching the web application of the present invention, the platform is displayed. A My Project page (10) is shown first to the user upon logging in. The My Project page (10) displays each of the projects that the user is working on as a file name. Upon selection of a project in progress from the My Project page (10), the wall (20) of the project is shown. The wall (20) is configured to transform in appearance in accordance with the zoom level indicated by the user. The wall is preferably displayed within the My Project page (10) after selection of a project in progress, or as a new project is created. Tabs are displayed at a top or a bottom of the My Project page (10), which aid in navigation within the platform of the present invention. The tabs are mechanisms for navigation to other pages of the platform (10), including a Shared Projects page, and Others' Projects page. These mechanisms may be represented by multiple graphical implementations, including but not limited to, buttons, icons, or physical keys mapped to a conventional computer keyboard. The My Project page (10) preferably includes mechanisms for navigation to join another's project via a join code. When a project is loaded and displayed on the wall (20), the user is provided zoom buttons (60). The zoom buttons (60) preferably enable the manipulation of the display of the wall (20), including the following:
The view of every scene (frame) gets less detailed automatically as the user zooms out.
The view of every scene (frame) gets more detailed automatically as the user zooms in.
   For example: If we were to look at the cinematography line from the lobby level, in every single frame, we can only see one picture from that frame's storyboard page. However, as we zoom in, every frame becomes more detailed.
      Lobby>One picture
      Level 1>the full page of the storyboard.
      Level 2>detailed description of a single picture.
      Level N, etc.

It should be noted that the above is merely one example configuration of many. The users individually decide how much detail they wish to view on their device for each level or department via the zoom function activated with the zoom buttons (60). The users independently decide what is important for them see, even if multiple users are viewing the same project simultaneously. Without user interaction, the platform is configured to automatically select pertinent zoom-level content for each frame. The “Vision Lock” feature of the platform of the present invention is preferably activated via a vision lock button (75). When the vision lock button (75) is clicked/tapped, the platform disables the automatic zoom transformation of the wall (20), and allows the user to zoom in and zoom out without transformation of the wall (20).

The platform and system of the present invention provides users with a variety of views and tools to facilitate the creation of an expedient and effective film production. In short, the tabs amount to selection mechanisms by which users may select, or navigate to the following features of the platform:
My Projects page (10)
Others' Projects view—Displays projects that others have shared with this user's account.
Publish function—When the user wants to share the movie break downs and work process with anyone online, the Publish option offers a way of easily doing so. Non-account holders would be able to see and interact with what is published.
Share function—Enables users to share a project with others via a join code, or similar invite mechanism.

Additionally, the platform of the present invention is equipped with the ability to share and/or work simultaneously on a project with others. When a user wants to share a project with others (even if they are not registered users of the platform of the present invention), a join code can be created and sent to all users that the account-holder wishes to share the project with. This join code, created when the user employs the share function, allows these users to access and work on the shared project, preferably restricted to viewing content only, unless permission is provided.

A Search field, which preferably appears on all screens of the platform, has various functions depending on which window a user is operating within, such as:
1. Within a project, the contents of that specific project are searched against the search term(s) entered within the search field.
2. Outside of a specific project, the search field has 2 functions: (1) to search for other users' publicly published projects by title, name, artist, or any other keyword and (2) to search for and/or join projects using the join code created when a user selects other specific users to share their project with privately.
3. When a user fills out the search field and presses enter or the search button, the display of the platform changes to display the search results, including ratings for each break-down, template, or public domain film.
4. When a user clicks on one of the project icons, it will be viewed online without downloading, and the user will not be able to edit the content. (There is no separate button to click on for the project, users click on the icon to open the project.) Projects are not editable until they are downloaded or added to the account cloud, and viewed from the My Project page.

### Downloading and Online/Offline Editing Modes

Users click a download button to start downloading or adding to the account cloud storage. Once clicked, the user will have the option to ‘download to device,’ or ‘download to a cloud-based account storage.’
a. Material downloaded to a device's hardware can be edited in offline edit mode.
b. OR if a user is online, they can add the project to the account's cloud and edit in online edit mode.
If a project has already been downloaded to ready-to-use templates, green check mark symbol is shown.
During the process of downloading, a filling arrow marks progress of the download.
Ready movie breakdowns can be viewed online without being downloaded, but they must be downloaded for editing.

### Online and Offline Editing Modes:

The platform of the present invention may also be used in a limited fashion offline in an Offline mode. In the offline mode, a version of the platform is downloaded to the local computer or mobile device of the user in its entirety for complete use offline. Changes are merged with the online mode when the user logs back online. Preferably changes are primarily made when connected online, and offline mode is reserved for viewing and reviewing information.

Additionally, a standard online mode is provided, which includes the ability to edit in real-time. Other modes include:

A.) Offline Editing Mode, though still connected to the internet, allows users to work on projects stored on their device so that the quality or speed of the internet connection does not affect their work. Changes made to work are synced to the cloud in ways that do not affect the speed of the work.

B.) Online Editing Mode allows users to work on projects without having to download them to their device.

The system of the present invention is preferably equipped with a wide variety of ready-made Project Templates to facilitate creation of content on the platform of the present invention. Templates offered on the platform preferably include the following forms:

1. Ready-to-go Templates

The platform of the present invention is equipped with pre-designed templates having different background pictures, motifs, frame shapes, and themes. These are preset templates into which the user can simply enter information. The user has the capability to change the aesthetic if desired, but it is ready to go as-is.

2. Build-Your-Own Templates

Additionally, users are provided the option to add all design elements to blank template, including background, motif, title design, and choose how long the timeline will be.

Motif differences: for example, templates may have different shaped frames according to variations in the motif of the film to be directed and produced. While one template may exhibit a circular frame, another template may have square shaped frames instead. There may also be differences in title design. Or, while one's title style written with abstract art, another one may have simple title design with a simple font.

3. Find Published Movie Templates

Any template can be used for any length of audio or video, including feature film length (120 minutes). When the user uploads audio or video material (in an attempt to create a new project), the timeline will automatically adjust to correspond to the length of the material uploaded to the template. The user can choose or change how long the timeline will be manually as well.

The different templates are preferably configured to exhibit different themes according to the kind of timeline the user is using, i.e. for music video, television, or film. Theme difference is the big change for the timeline. While one theme has a regular timeline with seconds apart, another theme can have a music timeline. The music timeline is for music videos. This timeline is the one that has the song on it, other than having empty video timeline. The music timeline can play the song when the timeline is in play mode. When the user uploads audio material in an attempt to create a new project, the timeline will automatically adjust to correspond to the length of the material uploaded to the template.

4. Find More Templates Online

Users are provided the option to search online, within communities which share files compatible with the platform of the present invention. Template files created by other users may be shared among users, and stored centrally on the secured server computer. Ready Movie Break-downs made by other users are available. Additionally, a template can be combined with two different movies. For example, if a user has two favourite films and the user wishes to do something that have components of both, the user can combine the two films via their layout and structure to create a new project.

Wall View Manipulation Via Zoom in/Out

One of the main advantages of the platform and system of the present invention is the ability to navigate using zoom-in and zoom-out functions, which allow users to see everything at once. The view of the screen window must always be able to take the smallest frame on the wall and display it full screen view. This is done by using mouse scroll wheel or touch screen's two-finger zooming motion. This view can be achieved faster by double clicking on the frames. Once a frame is double clicked on, the software zooms in to the frame and makes it a full screen view on the user's device. If the platform can not recognize the frame that wants to be zoomed in from its current view, the platform will first zoom-in to the scene frame that the smaller frame is in.

The wall (20) or main screen of the platform of the present invention transforms according to what the user wants to view. When navigating a scene by zooming in or out, the user sees various elements of the scene: single sentences, pictures, or drawings; depending on the user's choice. The user can set the section of time and which type of information viewed at a given moment, for example, only the master shoot drawings of the first act, or only the photos associated with the second act. The user can pick which parts of the project that they want to see and save their settings, locking their view so that they don't have to see material irrelevant to what they are currently working on in their view.

The Vision Lock feature (75) of the present invention keeps the user on the desired view level so that when the zoom buttons (60) are used, the user zooms in and out only on the current level the user is presently on, without navigating away from that level. The Vision Lock titles for each preset zoom level have names like Lobby Level, Level 1, Level 2, Level 3, etc. The names may be customized by the user if desired.

Depending on the kind and size of screen that a user is navigating with, they can set their view accordingly by transforming the view of the wall (20) via the zoom buttons (60). A user with an iPad versus a computer with a large monitor at home may want to see more or less detail, dependent upon what will fit on the screen according to the size of the screen. Users can designate and change at any time a sentence, a photo, or a drawing associated with various acts, sequences, and scenes of the project, which will appear or disappear as the user zooms in and out. Users can designate multiple ways that they want to see the big picture or overview on the production wall (20).

The process for adding a scene to a project from the my project page (10) is preferably as follows:
1. Click ‘Add Scene’
2. Name the scene
3. Platform then automatically names the scene title accordingly within all created departments.
4. A location diagram is provided for the scene by the platform.

Upon selecting ‘Add Scene,’ the platform displays timing options to the user, such as 15 seconds, 30 seconds, etc. This can also be managed after the scenes are created by holding the edge of the scene, and dragging a timing slider to be shorter or longer. After addition of a scene, the scene may later be split if desired into multiple frames, i.e. 1 frame is now frame 2 or frame 3.

After scenes are created, characters may be added according to which scene(s) they appear in. Adding characters to scenes is preferably performed via the platform of the present invention as follows:
1. The user selects the ‘Add character’ button to add a character to a specific location.
2. A Character info box is provided to the user for input of various qualities of the character. Characters are preferably provided with an ‘info box.’ Within the info box, the information pertaining to each character may be easily viewed by any connected user.
3. An Auto-Character adder is activated if pertinent. This feature is built in software. It automatically analyzes the script, and adds in character names from the script accordingly.
4. Color coding the characters—This color coding allows users to separate characters easily. And most importantly, if there is a relation between one character and one location, it gives the character a corresponding belonging location.

### Storyboard Development:

A Storyboard playback option is available from the wall (20) to enable the user to view the present state of the planned project. When the story board of the project is equipped with pictures or drawings or gifs the platform will play them as video, which may be saved to the project. Drawings uploaded will be displayed one after another in sequence. The time of the shoot automatically starts at 3 sec. but will be also manually timed. The same shoot will be able to appear for the dialog of the scene. This allows the script to be seen as a cartoon, with the exact total run time of the movie elapsed. The script reader of the present invention can be used to play the storyboard with a voiceover in the background of the playback. Additionally, a slide-show can be produced via the storyboard so that the movie's total run time can be calculated with each take's screen standing in seconds. Transitions preferably appear between a picture or storyboard drawings in the storyboard play option. The script reader of the platform is a program that reads the scripts aloud to the user. In alternate embodiments of the platform of the present invention, different tones are available. The script reader is configured to analyze the words in the script from the dictionary within. and will speak them out as female or male, fast, slow emotional, robot narrator, etc.

Calendar scheduling tool is preferably available within the platform of the present invention:

Creating Production Calendar (CALENDAR MAKER)—The system and platform of the present invention is equipped with a production calendar maker, which facilitates planning of when and where scenes will be shot. For example, users are able to dictate when one location is picked for a day of shooting. In order to calculate the shoot-order of scenes, the calendar will ask the following questions:

1. Would you like the rate the distance of the scenes that are in this location? Would you like the rate progression of the scenes based on distance that are in this location?

2. Would you like to rate the time difference and the distance of the scenes that are in this location?

After a production calendar is made, the platform of the present invention inquires:
“Do You Want the platform of the present invention to Access Your Calendar And Alert You For Shoot-Days?”
If the user indicates ‘yes,’ the system of the present invention will port the Production Schedule to the users' phone, tablet, and/or computer, and port the calendar entries to pertinent calendar software, such as MS Outlook™, Google™ Calendar, and/or iOS™ calendar. With alarms, users can configure alarms for specific times and days. For example:
   Tomorrow's Shoot-days will be alarmed at 9 pm.
   Also 2 Hours before the shoot.
These alarms have the information of Location, along with various other film related Information, such as costume requirements if needed.
   Other features of the platform of the present invention include:
Prop diagrams may be produced on the platform to indicate which props are to be used for which scenes, and in which scene locations. The location of each prop within a scene of a production may be mapped via the prop diagram feature of the present invention.
Automatically changing Characters when a character name, appearance, or any other change has been made, the software of the present invention automatically changes the characters information in other cells too, such as in departments of the movie production, as well as throughout the time line.
Auto-get location: with a click of a button, the scenes that are in the same locations will be organized together. This can be performed for one or many locations once gathered and after (This is for an individual person's use; the depiction of the wall (20) only changes the view point of the user and his/her corresponding screen)
If a user wishes to break down a movie that he/she likes, the user places the video format of the movie into a empty, create-your-own template. Then, the platform asks the user, “Do you want to break down the whole movie?” Or “Do you want to just get pieces from this video?” Selection of either option leads the user to Quick Editing mode.
   “Do you want to break down the whole movie?”—Selection of this option by the user directs the user to movie view mode. The user then strikes the space bar every time a scene change occurs. At the end of the movie viewing, the user will have the movie broken down to scenes, which are then ready to analyze and get deeper into breaking down.
   “Do you want to just get pieces from this video?”—Upon selection of this option, the platform directs the user to an editing room-like window, allowing the user to have minutes of little videos or gifs portrayed as reference to the scenes.
Auto changing locations: when information about a location is changed, it will also be changed in all time lines but with a question asked: “Would you like to change just this location, all the others, or just specific ones?”
12 hours of cell save: The past 12 hours of work progress is automatically saved to cloud storage as a backup. This enables the user to see past work performed, and bring something back if needed. This 12 hour period of saved progress will be activated by the platform, if only there is a change been made in the cells.
Capability of making departments invisible which user's relevant information on top. (This is a individual person use; only changes the view point of the individual user and his/her corresponding screen)
Additionally, users are provided the capability to change the scenes order on the time line.
The platform affords users the capability of messaging between the cells, across departments. The platform of the present invention is configured to deliver notifications to the director and producer if any changes have been made in any cells. Changes are shown via the 12 hours of cell save—i.e. a comparison may be drawn between what the cell currently looks like right now, against what it appeared as before, depicted visually on the wall (20).
A non-effective messaging pen function enables drawing and script writing directly overlaid on the content of the project, which has the effect of enabling a user to provide input without making changes to cells. For example: the director has a opinion, idea, or argument about one specific object in costume department—this pen function enables the director to explain his ideas better by simply drawing.
Media management: no setting media like in final cut pro>which means the program will set the project media itself automatically somewhere in the computer.
The platform of the present invention is configured to export project files in a unique file format, which is preferably available with two options: 1) with media, or 2) without media.
A crew list is preferably listed at the very beginning of the time line as depicted on the wall (20).
Print Out Function: The platform of the present invention is configured to print out the timeline and wall (20) into a comprehensive book, similar to a production bible layer time line to real production bible by printing out. This will be possible by cell and frame in depicted in a side frame. For example, one cell for one scene, which is depicted on one page. if there are frames inside there will be the connection ideas that goes deeper. The Frame-in-frame depiction makes it 1 idea displayed its detailers. For example, in costume department at Scene #14 there is one cell with 3 little frames within it: A-frame, B-frame, and C-frame.
   And in the A-frame there are 4 other frames. Then the order of the folder will be as follows:

1. Whole cell
A-frame
   a. 1.frame
   b. 2.frame
   c. 2.5frame
   d. 3frame
B-frame
C-frame

It should be understood that the platform of the present invention is equipped with the capacity to execute every conventional video and text format, including .gif, .png, pdf, word, gph, .mpg, .mp4, .avi, etc. Additionally, it should be understood that the present invention employs a drag and drop interface, facilitating easy text editing, picture and/or video adding, and other manipulation of the film timeline from the my project page (10). Pictures may be edited within the platform with basic editing tools, such as cropping.

Example: plot shows to the audience Scene (B) driving a car, then (C) car accident, , , , then (A) argument with parents before driving the car. So in this case, the Plot shows (B)>(C)>(A). The real time plot option of the platform reorders the scene to when the events take place in real time and makes it (A)>(B)>(C). Therefore, each actor's hair, clothing can be tracked more easily.

Another prominent feature of the system and platform of the present invention is a production time calculation tool, which effectively estimates the amount of time required to shoot scenes indicated to the system, and the overall production time of the project. The platform of the present invention takes all the information entered during the pre-production part, and calculates how much time will be spend to shoot each scene at location during the production phase of the project. In a movie production, the production part comes after the pre-production part of a project, and it is where the scenes are shot at the locations with all the people who are working under that project. The present invention is configured to calculate the time spent at each location during the shoot by a built-in formula.

For example, the present invention takes the information previously entered during the pre-production part from each department like camera setup, camera setup change, light setup, light setup change, makeup, costume change, set design, number of actors/crew members who to do these jobs, and outputs the data of approximately how much time each scene should take to shoot with (and without) human error included in the estimation.

This formula adds the minutes of all duties that a specific crew member has to do, and calculates a total run-time for each individual. The present invention is therefore able to calculate each crew member's total run-time through the list of duties which is created according to their crew member title. Then, the formula overlays all the total run-times of each actor/crew member to locate duties that affect each others' workflow. The duties that effects 2 individuals' workflow can be seen in costume changes of an actor, and director's call of start shooting the scene. One of these two actions must be prioritized. In such an example, the costume change of the actor is the priority duty that needs to be completed in order for the director to call for the start of shooting. The present invention employs prior duty list building, which allows the platform of the present invention to pre-determine which duty comes first. The formula includes adding all the duties (and their estimated times based on history) that each individual needs to do, overlaying every actors/crew members' duty (for duties that may be performed simultaneously, or that must be in a specific order), then locating all the duties that affects each individuals' workflow, and then outputs the time that will take to shoot for a scene based on the added estimated timelines.

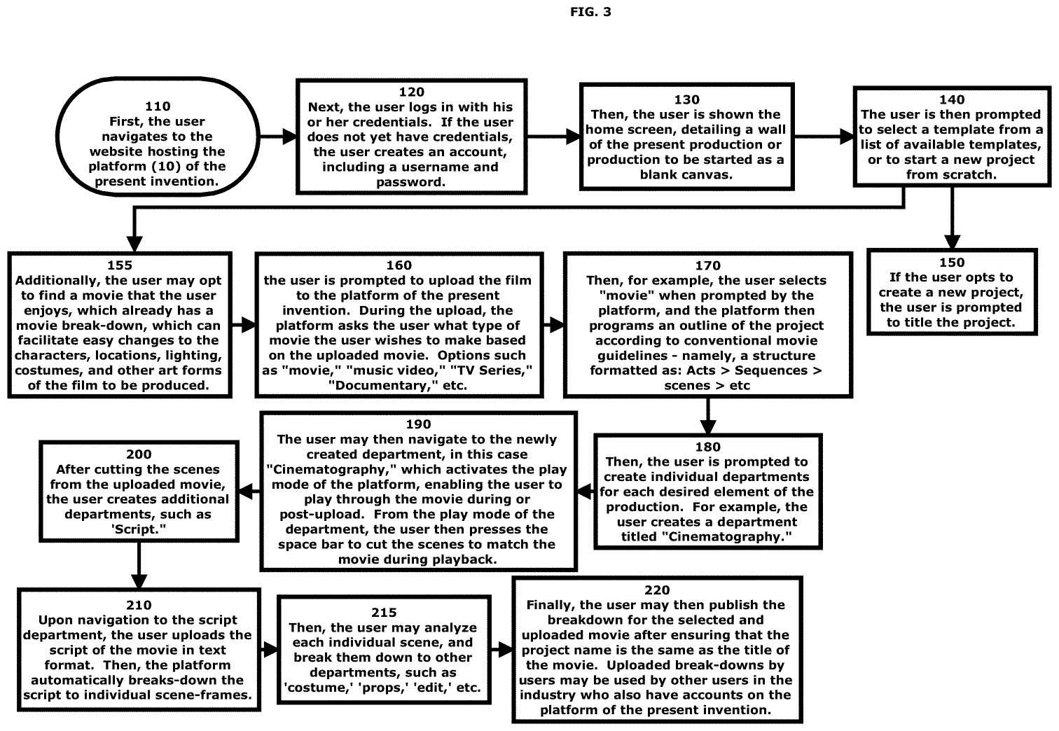

The present invention is designed such that it may be set up quickly in virtually any location. As such, the process of assembly and use of the present invention, as shown in FIG. 3, is preferably as follows:

1. First, the user navigates to the website hosting the platform (10) of the present invention. (110)

2. Next, the user logs in with his or her credentials. If the user does not yet have credentials, the user creates an account, including a username and password. (120)

3. Then, the user is shown the home screen, detailing a wall of the present production or production to be started as a blank canvas. (130) The wall is zoomed-out to is maximum setting, depicting an overview of the entire production as shown in FIG. 1.

4. The user is then prompted to select a template from a list of available templates, or to start a new project from scratch. (140) The templates serve to guide the user as he or she begins the organizational process. The templates include slots, blanks, and empty frames in which the user may begin to fill out the structure, script, and basic outline of the film. See the template section above for additional details pertaining to the templates made available on the platform of the present invention.

5A. If the user opts to create a new project, the user is prompted to title the project. (150)

5B. Additionally, the user may opt to find a movie that the user enjoys, which already has a movie break-down, which can facilitate easy changes to the characters, locations, lighting, costumes, and other art forms of the film to be produced. (155) If a break-down does not already exist for a movie the user enjoys, the user may opt to upload the movie so that a break-down may be created for future use.

6. If the user opts to create a new movie break-down (5B), the user is prompted to upload the film to the platform of the present invention. During the upload, the platform asks the user what type of movie the user wishes to make based on the uploaded movie. Options such as “movie,” “music video,” “TV Series,” “Documentary,” and other types of cinematic art are provided. (160)

7. Then, for example, the user selects “movie” when prompted by the platform, and the platform then programs an outline of the project according to conventional movie guidelines—namely, a structure formatted as: Acts>Sequences>scenes>etc. (170)

It should be noted that the main structure of the project created changes with other options as well. For example, if user were to select “TV series”, the program would give the user a different kind of structure/outline. The TV series structure starts with a main project wall, which then breaks down to seasons, which are also individual break-down projects. In these season projects, there are episodes which are individual break-down projects.

8. Then, the user is prompted to create individual departments for each desired element of the production. For example, the user creates a department titled “Cinematography.” (180)

9. The user may then navigate to the newly created department, in this case “Cinematography,” which activates the play mode of the platform, enabling the user to play through the movie during or post-upload. From the play mode of the department, the user then presses the space bar (or another designated button) to cut the scenes to match the movie during playback. (190)

10. After cutting the scenes from the uploaded movie, the user creates additional departments, such as ‘Script.” (200) Upon navigation to the script department, the user uploads the script of the movie in text format. Then, the platform automatically breaks-down the script to individual scene-frames. (210) The user is encouraged to go through the script and make sure the script department's scene-frames are matching with the cinematography department's scene-frames.

11. Then, the user may analyze each individual scene, and break them down to other departments, such as ‘costume,’ ‘props,’ ‘edit,’ etc. (215) This enables planning via each department for each individual scene seamlessly and easily, facilitating collaboration between departments.

12. Finally, the user may then publish the breakdown for the selected and uploaded movie after ensuring that the project name is the same as the title of the movie. Uploaded break-downs by users may be used by other users in the industry who also have accounts on the platform of the present invention. (220) Users may then search for the uploaded break-down via the search field (80) by entering the title of the film.

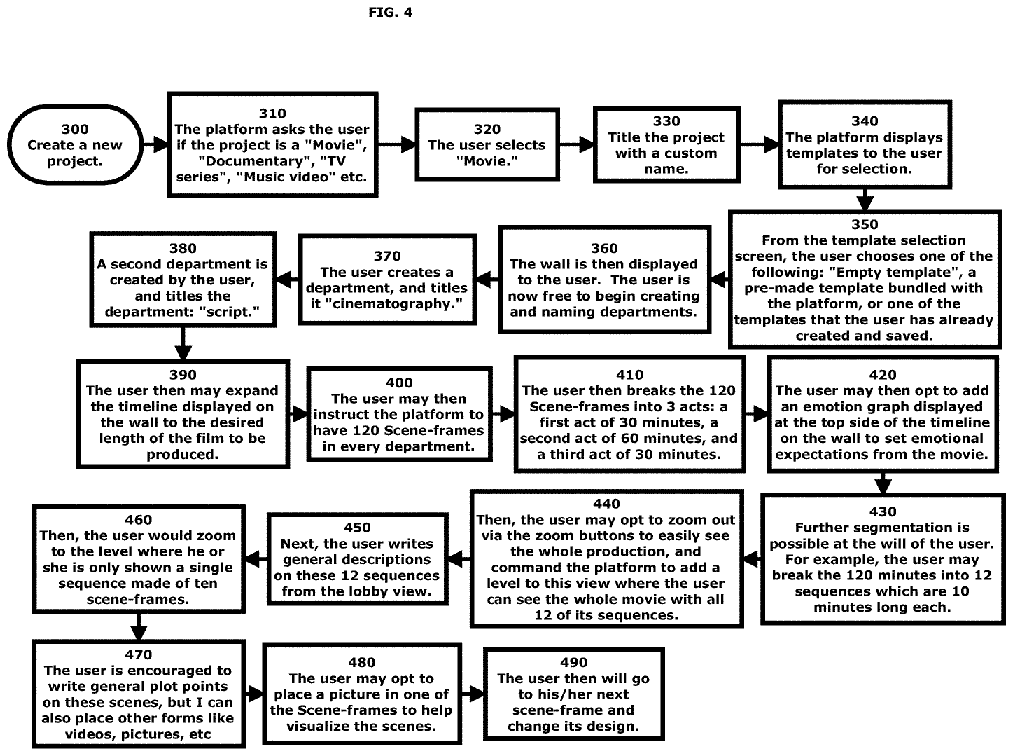

The following is an example of the process of use of the platform of the system of the present invention, in the creation of a new project, as depicted in FIG. 4:
1. Create a new project. (300)
2. The platform asks the user if the project is a “Movie”, “Documentary”, “TV series”, “Music video” etc. (310)
3. The user selects “Movie.” (320) Alternately, other projects may be selected.
4. Title the project with a custom name. (330)
5. The platform displays templates to the user for selection. (340)
6. From the template selection screen, the user chooses one of the following: “Empty template”, a pre-made template bundled with the platform, or one of the templates that the user has already created and saved. (350)
7. The wall is then displayed to the user. The user is now free to begin creating and naming departments. (360)
8. The user creates a department, and titles it “cinematography.” (370)
9. A second department is created by the user, and titles the department: “script.” (380)
10. The user then may expand the timeline displayed on the wall to the desired length of the film to be produced. (390) For example, the user may expend the timeline of the project to 120 minutes.
11. The user may then instruct the platform to have 120 Scene-frames in every department. (400)
12. The user then breaks the 120 Scene-frames into 3 acts: a first act of 30 minutes, a second act of 60 minutes, and a third act of 30 minutes. (410)
13. The user may then opt to add an emotion graph displayed at the top side of the timeline on the wall to set emotional expectations from the movie. (420) The user may alternately opt to create an emotion graph after the script is more developed. The emotional timeline/graph (50) of the present invention can be seen in FIG. 2. The time line view can show the emotional timeline/graph (50), which depicts each act of the film, and includes a summary of the emotional progression of the film. Each emotion line (55) details the emotional progression of a given character of the film in production. To return to the wall (20), users simply click the small portrayal or icon of the wall shown at the bottom left of the emotional timeline/graph (50) of the platform of the present invention.
14. Further segmentation is possible at the will of the user. For example, the user may break the 120 minutes into 12 sequences which are 10 minutes long each. (430)
15. Then, the user may opt to zoom out via the zoom buttons (60) to easily see the whole production, and command the platform to add a level to this view where the user can see the whole movie with all 12 of its sequences. (440)
16. The user may name the view level, zoomed all the way out, such as the name “City,” or the user may simply leave it with the default title of “lobby”.
17. This level view side toolbox (called elevator) has lock option for every level that is created, will allow me to zoom in and out with disabled wall transformation.
18. Next, the user writes general descriptions on these 12 sequences from the lobby view. (450)
19. Then, the user would zoom to the level where he or she is only shown a single sequence made of ten scene-frames. (460)
20. The user is encouraged to write general plot points on these scenes, but I can also place other forms like videos, pictures, etc. (470)
21. The user may opt to place a picture in one of the Scene-frames to help visualize the scenes. (480) To do so, the zoom into that frame (which is another workspace) and start placing other thing like pictures, videos, writing, word files, etc.
22. The user then will go to his/her next scene-frame and change its design. (490) In the event that the user does not want this frame space as messy as the first one, the user may start organizing this frame. The user selects select one of the pre-made frame designs which divides the frame into four separate frames. Now, if the user wishes to ‘drag and drop’ pictures or videos or any other form file, it will automatically take its place over which ever little frame the user places the cursor (drop).

It should be noted that, in all examples, the user is encouraged to share his or her work with other users, both in order to collaborate on the project, or to facilitate the creation of separate, unrelated projects. The user invites others to view, edit, and/or otherwise collaborate on the project. Invited users are preferably from various departments, as denoted above. Invited users are free to view at any time, even when changes are being made. Similarly, they may invite other users with permission may edit as well.

It also should be noted that, for the process of use of the platform of the present invention as depicted above, the term ‘movie’ may be understood to mean any form of video production, including a documentary, music video, television series, short film, feature film, etc.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method of organizing, coordinating, staging, and facilitating the direction of a theatrical performance by users collaborating comprising:
creating a new project on a network-connected platform on a computer;
the platform prompting the users to select the type of project to be created from the following list: movie, documentary, TV series, music video;
the platform prompting the users to title the project;
the platform displaying a wall screen to the users, the wall screen exhibiting a timeline of the project in creation;
the platform prompting the users to create at least one department and to title the at least one department;
the platform displaying templates for selection based on the selected project;
the platform providing access to movie breakdowns based on existing theatrical performances to serve as a foundation for the timing, locations, characters, lighting, and costumes to be edited according to the newly created project;
the platform pre-populating the wall screen according to the movie breakdown selected by the users;
the platform prompting users to add characters, scenes, and acts to the timeline;
the platform prompting users to add brief descriptions of the events of each scene as performed by the characters;
the platform prompting users to group scenes into acts;
the platform displaying the grouped scenes as acts on the wall screen as a timeline of the theatrical performance;
the platform prompting users to script out each scene of each act in text fields;
the platform storing the script to a secured server computer; and
the platform guiding the users through the production of the theatrical production.

2. The method of claim 1, wherein departments include selections from the following list:
script, cinematography, choreography, costume, props, and editing.

3. A computer-based system configured to facilitate the organization, coordination, and execution of a theatrical performance by users comprising:
a server computer, said server computer connected to the internet hosting a collaboration and organizational platform on a website;
said collaboration and organizational platform exhibiting a timeline wall;
wherein said timeline wall is scalable such that it may be zoomed in to a detailed moment in the timeline of the theatrical performance;
wherein said timeline wall is scalable such that it may be zoomed out to depict an overview of the entire production of the theatrical performance;
templates, said templates posed to users to inform the foundation of the theatrical production;
wherein said templates include timing slots, blanks, and empty frames in which users are prompted to fill out the structure, script, and basic outline of the theatrical performance;
segregated departments, said segregated departments outlined on said timeline wall, titled by the users;
wherein said segregated departments compartmentalize aspects of the theatrical performance including script, cinematography, choreography, lighting, costume, props, and editing;
an emotional timeline graph, said emotional timeline graph is a digital representation of the emotional progression of the theatrical production on an act-by-act basis;
wherein said emotional timeline graph depicts an emotion line pertaining to the emotional progression of each character of the theatrical production;
text fields, said text fields configured to receive plot points of the theatrical production;
pre-existing movie breakdowns, said pre-existing movie breakdowns to be selected by users to mimic the timing and length of known completed theatrical performances;
wherein said pre-existing movie breakdowns facilitate changes to the characters, locations, lighting, costumes, and timing of the theatrical production in creation; and
wherein said changes to said pre-existing movie breakdowns and content of said text fields are saved to said secured server computer.
